(19) United States
(12) Patent Application Publication
(10) Pub. No.: US 2025/0287957 A1
(43) Pub. Date: Sep. 18, 2025

(54) FIELD DRESSING APPARATUS AND METHOD

(71) Applicant: Peter A. Heminger, North Salem, IN (US)

(72) Inventor: Peter A. Heminger, North Salem, IN (US)

(21) Appl. No.: 18/653,803

(22) Filed: May 2, 2024

Related U.S. Application Data
(60) Provisional application No. 63/566,788, filed on Mar. 18, 2024.

(51) Int. Cl. A22B 5/00

(52) U.S. Cl. CPC A22B 5/0023; A22B 5/0005; A22B 5/0047

(57) ABSTRACT

A field dressing apparatus includes an elongated handle. The handle includes a first end and a second end. The apparatus also includes a head member. The head member includes an at least generally planar, at least substantially smooth first surface. The head member further includes an at least substantially smooth second surface cresting apart from the first surface. The head member further includes an at least substantially smooth tip extending between the first surface and the second surface. The apparatus also includes a blade fixedly attached to and extending between the second end of the handle and the first surface of the head member. The blade includes a blade edge. The blade edge and the first surface of the head member together form a notch in front of the blade edge.

### CROSS-REFERENCE TO RELATED APPLICATION(S)

This application claims the benefit of priority of U.S. Provisional Patent Application No. 63/566,788, filed Mar. 18, 2024, entitled FIELD DRESSING APPARATUS AND METHOD, the disclosure of which is incorporated herein by reference.

### FIELD OF THE INVENTION

The present disclosure pertains to hunting and, more particularly, to apparatuses and methods for field dressing game animals.

### BACKGROUND

Historical tools and approaches for splitting sternums and pelvises of killed game animals during field dressings have undesirably ruptured internal organs of the animals, resulting in undesirably tainted (and wasted) meat.

### SUMMARY OF THE INVENTION

One or more embodiments provide a field dressing apparatus including an elongated handle. The handle includes a first end and a second end. The apparatus also includes a head member. The head member includes an at least generally planar, at least substantially smooth first surface. The head member further includes an at least substantially smooth second surface cresting apart from the first surface. The head member further includes an at least substantially smooth tip extending between the first surface and the second surface. The apparatus also includes a blade fixedly attached to and extending between the second end of the handle and the first surface of the head member. The blade includes a blade edge. The blade edge and the first surface of the head member together form a notch in front of the blade edge.

One or more embodiments provide a field dressing method including nestling a portion of a bone located inside a dead game animal within a notch formed by a blade edge of a first tool and an at least substantially smooth first surface of a head member of the first tool. The method also includes, concurrently with the nestling, positioning the head member of the first tool between the bone and an internal organ of the animal. The method also includes, concurrently with the positioning, abutting the first surface of the head member against the bone. . . . The method also includes, concurrently with the abutting, facing an at least substantially smooth second surface of the head member toward the internal organ. The method also includes causing the first tool to cut the bone. The causing includes striking the first tool with a second tool.

One or more embodiments provide a field dressing apparatus including a handle having a first end and a second end. The apparatus also includes an edged means, extending from the first end of the handle, for cutting an animal bone. The apparatus also includes an at least substantially smooth means, extending from the edged means, for guiding the edged means through the bone and for spacing the edged means apart from an internal organ of the animal concurrently with guiding the edged means though the bone. The at least substantially smooth means and the edged means are configured to cooperate to nestle a portion of the bone therebetween.

### BRIEF DESCRIPTION OF THE DRAWINGS

Some of the figures shown herein may include dimensions. Further, the figures shown herein may have been created from scaled drawings, scaled models, or from photographs that are scalable. It is understood that such dimensions, or the relative scaling within a figure, are by way of example, and not to be construed as limiting unless so stated in a claim. Persons of ordinary skill will also recognize that computer-aided design (“CAD”) renderings may include lines that pertain to changes in surface geometry, and not necessarily to component features.

FIG. 1 is a front perspective view illustration of a first field dressing apparatus in accordance with aspects of the present disclosure.

FIG. 2 is a left side plan view illustration of the first field dressing apparatus.

FIG. 3 is a right side plan view illustration of the first field dressing apparatus.

FIG. 4 is a top plan view illustration of the first field dressing apparatus.

FIG. 5 is a bottom plan view illustration of the first field dressing apparatus.

FIG. 6 is a plan view illustration of a white-tailed deer buck toward a beginning of field dressing operations in accordance with aspects of the present disclosure.

FIG. 7 is a perspective schematic illustration of the first field dressing apparatus cutting either of the buck's pelvis or the buck's sternum during the field dressing operations.

FIG. 8 is a side schematic illustration of the first field dressing apparatus cutting either of the buck's pelvis or the buck's sternum during the field dressing operations.

FIG. 9 is a plan view illustration of the buck toward an end of the field dressing operations.

FIG. 10 is a perspective view illustration of the first field dressing apparatus cutting wood in accordance with aspects of the present disclosure.

FIG. 11 is a right side plan view illustration of a second field dressing apparatus in accordance with aspects of the present disclosure.

### DETAILED DESCRIPTION OF ONE OR MORE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention, and further permits the reasonable and logical inference of still other embodiments as would be understood by persons of ordinary skill in the art. Unless expressly described or claimed herein as particularly limited to one or more specific materials, any component of the invention may be made from any one or more suitable metals, plastics, woods, fabrics, fibers, and/or combination(s) thereof (and/or any other suitable material(s) or combination(s) thereof) as would be understood by one of ordinary skill in the art.

It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “various embodiments” or “preferably,” refers to features and aspects that are present in at least one embodiment, but which are optional for some embodiments, it therefore being understood that use of the word “preferably” implies the term “optional.”

Like reference numerals refer to like parts throughout the description and the drawings. Additionally, the use of an N-series prefix for an element number (NXX.XX) refers to an element that is the same as the non-prefixed element (XX.XX), except as shown and described. As an example, an element 1020.1 would be the same as element 20.1, except for those different features of element 1020.1 shown and described. Further, common elements and common features of related elements may be drawn in the same manner in different figures, and/or use the same symbology in different figures. As such, it is not necessary to describe the features of 1020.1 and 20.1 that are the same since these common features are apparent to a person of ordinary skill in the related field of technology. Further, it is understood that some features 1020.1 and 20.1 may be backward compatible, such that a feature of a later discussed embodiment (NXX.XX) may include features compatible with other various embodiments that were discussed earlier (MXX.XX), as would be understood by those of ordinary skill in the art. This description convention also applies to the use of prime (′), double prime (″), triple prime (′″) and star or asterisk (*) suffixed element numbers. Therefore, it is not necessary to describe the features of 20.1, 20.1,′ 20.1,″ 20.1′″ and 20* that are the same, since these common features are apparent to persons of ordinary skill in the related field of technology.

What follows are paragraphs that express particular embodiments of the present invention. In those paragraphs that follow, some element numbers may be prefixed with an “X” indicating that the words pertain to any of the similar features shown in the drawings or described in the text. However, those of ordinary skill in the art will recognize various other non-X prefixed element numbers that discuss features applicable to other embodiments.

This document may use different words to describe the same element number, or to refer to an element number in a specific family of features (NXX.XX). It is understood that such multiple, different words are not intended to provide a redefinition of any language herein. It is understood that such words demonstrate that the particular feature can be considered in various linguistical ways, such ways not necessarily being additive or exclusive. As used in this description and the claims, the term “smooth” means blunt, free of sharp edges, and free of pits, pinholes, cracks, crevices, inclusions, rough edges and other surface imperfections detectable by visual and tactile inspection, so as to hinder cutting, snagging, tearing, and/or other rupturing of internal animal organs as a result of rubbing against or otherwise contacting them, and generally conforming to the historical U.S. Centers for Disease Control and Prevention (“CDC”) and National Sanitation Foundation (“NSF”) food handling definition of “smooth” (i.e., a “surface, free of pits and inclusions, having a cleanability equal to a No. 3 finish (100 grit) on stainless steel”).

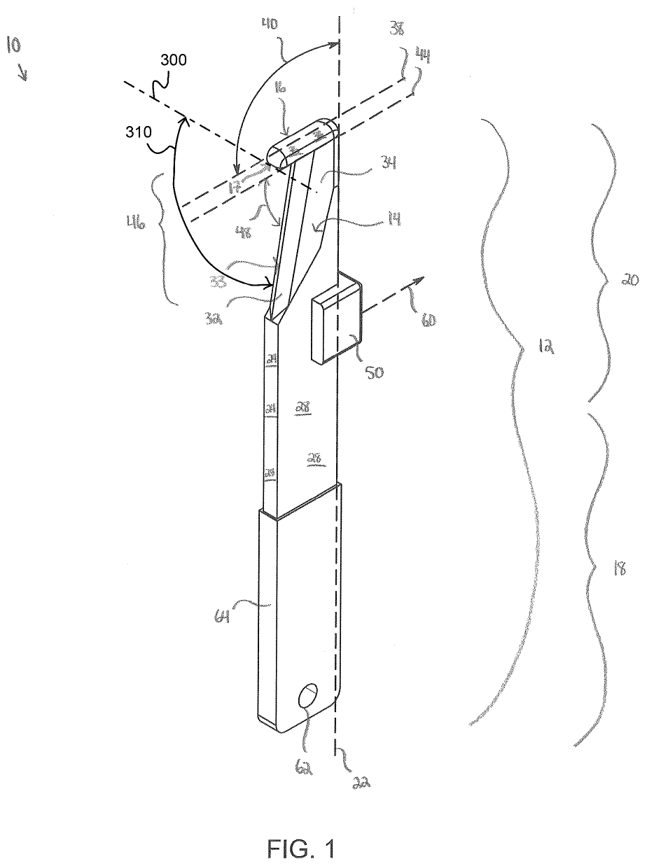

FIG. 1 is a front perspective view illustration of a first field dressing apparatus 10 in accordance with aspects of the present disclosure. The field dressing apparatus 10 may be made of stainless steel or any other suitable material(s). In some embodiments, the field dressing apparatus 10 may be forged from a single piece of metal and then tooled into the disclosed form(s). In some embodiments, the field dressing apparatus 10 may be fabricated from two or more components that are welded, glued, or otherwise suitably fixedly joined together.

The field dressing apparatus 10 comprises an elongated handle 12, a blade 14, and a tapered head 16. The handle 12 includes a butt end portion 18 and a longitudinally opposing blade attachment end portion 20, and extends longitudinally along a line 22. The handle also includes a front side 24, a back side 26, a left side 28, and a right side 30.

The blade 14 extends generally longitudinally from the end portion 20 of the handle 12, has an edged front portion 32, and has a spine or back portion 34 extending from the front portion 32. The portion 32 includes a blade edge 33. The portion 32 and the edge 33 are linear or substantially linear, and are angled or slanted relative to the longitudinal line 22. In some embodiments, the portion 32 and the edge 33 may have a piecewise linear geometry. In some embodiments, the portion 32 and the edge 33 may have a curved or curvy (non-linear) geometry.

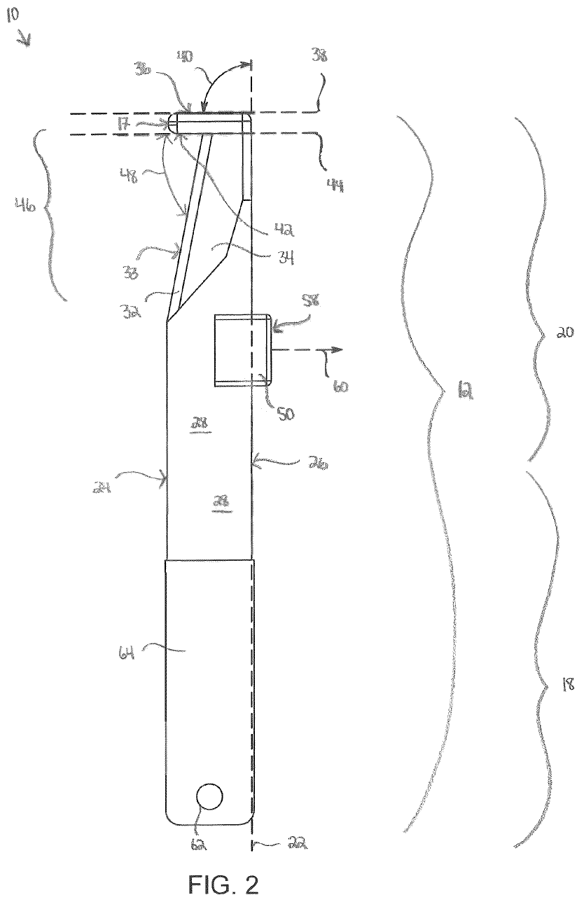

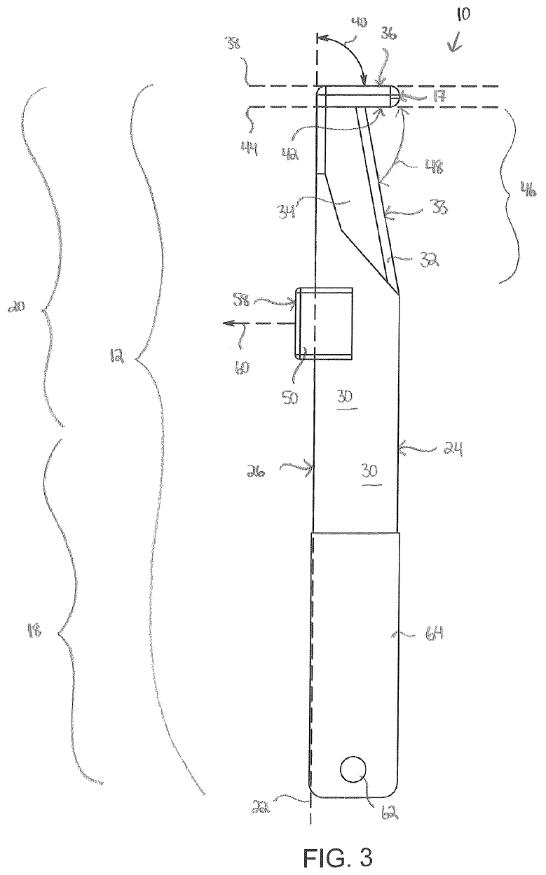

The tapered head 16 is fixedly attached to the edged front portion 32 and back portion 34 of the blade 14, and extends from the attachment end portion 20 of the handle 12 generally toward the front side 24 of the handle 12. The tapered head 16 includes an at least substantially smooth, rounded top surface 36 laterally cresting and extending longitudinally along a line 38 that is perpendicular or about perpendicular to the line 22. It should be appreciated, then, that an angle 40 between the line 38 and the line 22 is 90° or about 90°. The tapered head 16 also includes an at least substantially smooth, substantially planar bottom surface 42 (not marked in FIG. 1, but see FIGS. 2-3) extending from the end portion 20 of the handle 12. The surface 42 extends longitudinally across the blade 14 along a line 44, with the line 44 being parallel or about parallel to the line 38. A portion of the surface 42 contacts the blade edge 33, and the surface 42 further extends longitudinally therefrom such that the surface 42 (along the line 44) and edge 33 form a notch 46 (in front of the edge 33) having an interior angle 48 of about 90° or less than about 90°. In some embodiments, the angle 48 may be between about 75° and about 85°. In some embodiments, the angle 48 may be equal to or about 77°. The surface 42 also extends laterally across the blade 14 along a line 300, with the line 300 being perpendicular or about perpendicular to the edge 33 (i.e., the line 300 is angularly displaced from the edge 33 by an angle 310 of 90° or about 90°). The tapered head 16 also includes an at least substantially smooth tip 17 extending between the bottom surface 42 and the top surface 36. In some embodiments, the tapered head 16 may be rounded on its bottom side (instead of having the substantially planar bottom surface 42).

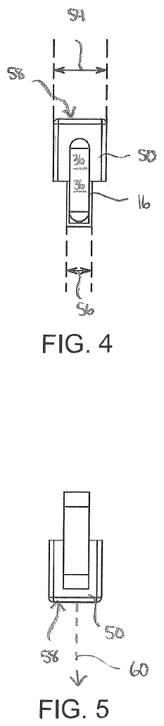

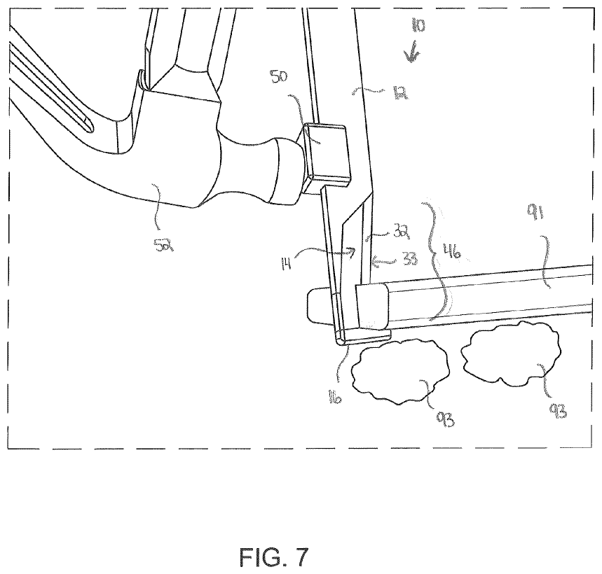

The handle 12 also comprises an impact block 50. The impact block 50 is configured to receive and transfer the energy/force from a hammer 52 or other striking instrument (not expressly illustrated in FIG. 1, but see FIGS. 7-8 and FIG. 10) to the blade 14. The impact block 50 has a lateral span 54 (not marked in FIG. 1, but see FIGS. 4-5) that is greater than the lateral span 56 (not marked in FIG. 1, but see FIGS. 4-5) of the handle 12, such that the impact block 50 extends laterally beyond each side of the handle 12. Further, the impact block 50 has a substantially planar outwardly facing surface 58 (not marked in FIG. 1, but see FIGS. 2-5). The surface 58 faces in a direction 60 that is perpendicular or about perpendicular to the longitudinal line 22. In the embodiment shown in FIG. 1, the impact block 50 has a generally rectilinear shape. In some embodiments, the impact block 50 may have a curved or non-linear geometry.

The first portion 18 of the handle 12 defines a hole 62 therethrough. It should be appreciated that the hole 62 may be used for, among other things, threading a small rope through the handle 12 and/or hanging the field dressing apparatus 10 on a pegboard or other storage structure. Additionally, the first portion 18 of the handle 12 includes a grip 64 disposed on the butt end portion 18. The grip 64 may facilitate a user's clutching of the handle 12, and may be made of a rubber, leather or other animal hide, or any other suitable material. In some embodiments, the grip 64 may be omitted.

In some embodiments, the field dressing apparatus 10 may have an overall length of approximately eleven inches (27.94 cm). In some embodiments, the handle 12 may have a width of approximately one inch (2.54 cm) and a thickness of approximately ¼ inch (0.64 cm). In some embodiments, the tapered member 16 may have a length of approximately one inch (2.54 cm) and a width of approximately ¼ inch (0.64 cm). In some embodiments, the grip 64 may have a length of approximately four inches (10.16 cm). In some embodiments, the hole 62 has an approximately ¼ inch (0.64 cm) diameter.

FIG. 2 is a left side plan view illustration of the apparatus 10.

FIG. 3 is a right side plan view illustration of the apparatus 10.

FIG. 4 is a top plan view illustration of the apparatus 10.

FIG. 5 is a bottom plan view illustration of the apparatus 10.

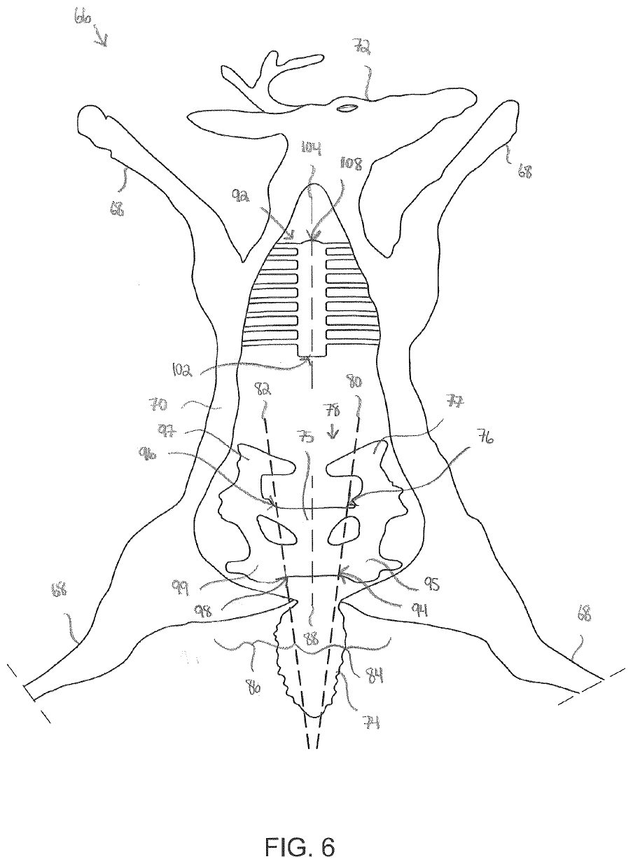

FIG. 6 is a plan view illustration of a white-tailed deer buck 66 toward a beginning of field dressing operations in accordance with aspects of the present disclosure. To use the apparatus 10 in field dressing the buck 66 (the apparatus 10 is not expressly illustrated in FIG. 6, but see FIGS. 1-5 and 7-8), a hunter or other user (not expressly illustrated) lays the buck 66 on the buck's back (not marked) and splays the buck's legs 68 generally laterally outward from the buck's trunk 70. Next, using a hunting knife or other suitable tool, the user cuts open the buck's trunk 70; more particularly, the user cuts through the abdominal and pelvic portions of the buck's hide, making an incision starting just caudally of a generally caudal portion 102 of the buck's sternum 92 and ending near the buck's tail 74.

Next, the user turns the apparatus 10 upside down and abuts the blade edge 33 against a first generally cephalic portion 76 of the pubis 75 of the buck's pelvis 78 (about where the buck's right illium 77 extends cephalically from the pubis 75), in alignment with a first desired pelvic cut line 80 located generally to a first side 84 of a pelvic midline 88 extending through the buck's pelvis 78, with the tapered head 16 positioned between the posterior side (not marked) of the pelvis 78 and the anterior side (not marked) of the buck's pelvic organs 90, and with the impact block 50 positioned generally between the buck 66 and the user, such that the surface 42 of the tapered head 16 abuts the posterior side of the pelvis 78 and extends generally caudally from the part 76, and such that the portion 76 is nestled in the notch 46 formed between the blade edge 33 and the surface 42.

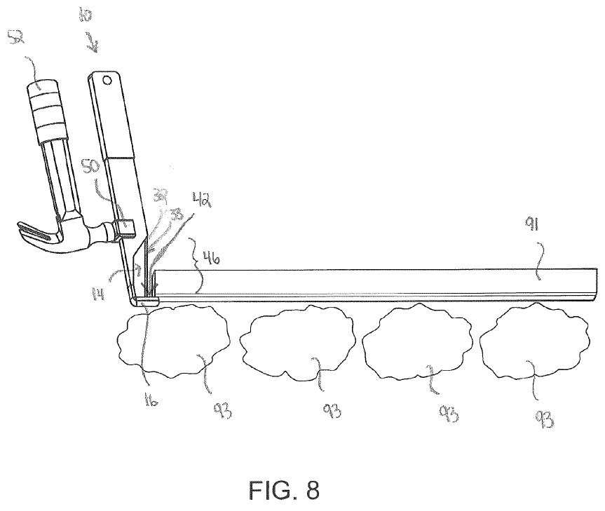

Next, the user drives the blade 14 through the pubis 75 (along the line 80), by repeatedly striking the impact block 50 with a hammer 52 (or rock, or other suitable tool) while clutching the grip 64. FIG. 7 is a perspective schematic illustration of the apparatus 10 cutting either of the buck's pelvis 78 or the buck's sternum 92. And FIG. 8 is a side schematic illustration of the apparatus 10 cutting either of the buck's pelvis 78 or the buck's sternum 92. In FIGS. 7 and 8, the bone 91 represents the buck's pelvis 78 or the buck's sternum 92 and the internal organs 93 represent the buck's pelvic organs 90 or the buck's chest organs 106, respectively. Here, it should be appreciated that the tapered head 16 guides the blade edge 33 relative to the bone 91 and spaces the edge 33 apart from the internal organs 93, which impedes the edge 33 from rupturing the internal organs 93. Further, it should be appreciated that the shape and smoothness of the tapered head 16 impede the tapered head 16 from rupturing the internal organs 93. The user repeatedly strikes the impact block 50 until the user has caused the apparatus 10 to cut the buck's pelvis 78 (along the line 80, see FIG. 6) through the portion 76 and all the way through a first generally caudal portion 94 of the pubis 75 (about where the right ischium 95 of the pelvis 78 extends cephalically from the pubis 75).

Next, with apparatus 10 upside down the user abuts the blade edge 33 against a second generally cephalic portion 96 of the pubis 75 of the buck's pelvis 78 (about where the buck's left ilium 97 extends cephalically from the pubis 75), in alignment with a second desired pelvic cut line 82 located generally to a second side 86 of a pelvic midline 88 extending through the buck's pelvis 78, with the tapered head 16 positioned between the posterior side (not marked) of the pelvis 78 and the anterior side (not marked) of the buck's pelvic organs 90, and with the impact block 50 positioned generally between the buck 66 and the user, such that the surface 42 of the tapered head 16 abuts the posterior side of the pelvis 78 and extends generally caudally from the portion 96, and such that the portion 96 is nestled in the notch 46 formed between the blade edge 33 and the surface 42.

Next, the user drives the blade 14 through the pubis 75 (along the line 82), by repeatedly striking the impact block 50 with a hammer 52 (or rock, or other suitable tool) while clutching the grip 64. Again, FIG. 7 is a perspective schematic illustration of the apparatus 10 cutting either of the buck's pelvis 78 or the buck's sternum 92. And FIG. 8 is a side schematic illustration of the apparatus 10 cutting either of the buck's pelvis 78 or the buck's sternum 92. And, again, in FIGS. 7 and 8, the bone 91 represents the buck's pelvis 78 or the buck's sternum 92 and the internal organs 93 represent the buck's pelvic organs 90 or the buck's chest organs 106, respectively. Here again, it should be appreciated that the tapered head 16 guides the blade edge 33 relative to the bone 91 and spaces the edge 33 apart from the internal organs 93, which impedes the edge 33 from rupturing the internal organs 93, and it should be appreciated that the shape and smoothness of the tapered head 16 impede the tapered head 16 from rupturing the internal organs 93. The user repeatedly strikes the impact block 50 until the user has caused the apparatus 10 to cut the buck's pelvis 78 (along the line 82, see FIG. 6) through the portion 96 and all the way through a second generally caudal portion 98 of the pubis 75 (about where the left ischium 99 of the pelvis 78 extends cephalically from the pubis 75).

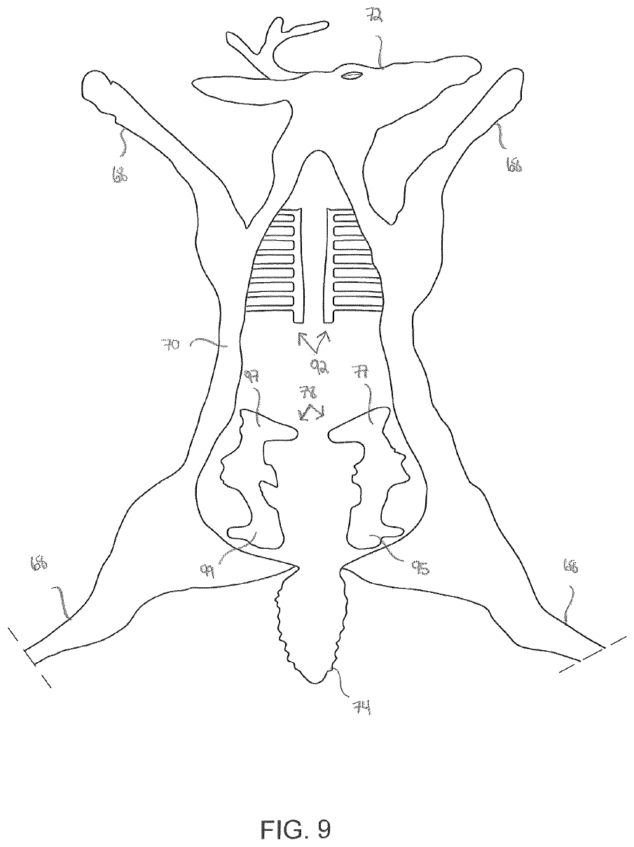

Next, the user removes the buck's pubis 75 (which, as described above, the user has cut apart from the ilial and ischial portions of the pelvis 78) from the buck 66. Then, the user generally laterally splays the ilial and ischial portions of the pelvis 78, and the user removes the buck's pelvic organs 90. FIG. 9 is a plan view illustration of the buck 66 toward an end of the field dressing operations. In FIG. 9, the pubis 75 (not expressly illustrated in FIG. 9, but see FIGS. 6-8) and the buck's the internal organs 93 (not expressly illustrated in FIG. 9, but see FIGS. 6-8) have been removed in accordance with aspects of the present disclosure.

Next, with the apparatus 10 upside down the user abuts the blade edge 33 of the edged front portion 32 of the blade 14 against the generally caudal portion 102 of the buck's sternum 92, in alignment with a sternum midline 104, with the tapered head 16 positioned between the posterior side (not marked) of the sternum 92 and the anterior side (not marked) of the buck's chest organs 106, and with the impact block 50 positioned generally between the buck 66 and the user, such that the surface 42 of the tapered head 16 abuts the posterior side of the sternum 92 and extends generally cephalically from the portion 102, and such that the portion 102 and the hide covering it are nestled in the notch 46 formed between the blade edge 33 and the surface 42.

Next, the user drives the blade 14 through the sternum 92 and the hide covering it (along the midline 104), by repeatedly striking the impact block 50 with a hammer 52 (or rock, or other suitable tool) while clutching the grip 64. Again, FIG. 7 is a perspective schematic illustration of the apparatus 10 cutting either of the buck's pelvis 78 or the buck's sternum 92. And FIG. 8 is a side schematic illustration of the apparatus 10 cutting either of the buck's pelvis 78 or the buck's sternum 92. And, again, in FIGS. 7 and 8, the bone 91 represents the buck's pelvis 78 or the buck's sternum 92 and the internal organs 93 represent the buck's pelvic organs 90 or the buck's chest organs 106, respectively. Once more, it should be appreciated that the tapered head 16 guides the blade edge 33 relative to the bone 91 and spaces the edge 33 apart from the internal organs 93, which impedes the edge 33 from rupturing the internal organs 93, and that the shape and smoothness of the tapered head 16 impede the tapered head 16 from rupturing the internal organs 93. The user repeatedly strikes the impact block 50 until the user has caused the apparatus 10 to cut the buck's sternum 92 and the hide covering it (along the midline 104, see FIG. 6) through the generally caudal portion 102 and all the way through a generally cephalic portion 108 of the sternum 92. Then, the user generally laterally splays the cut portions of the sternum 92 and the hide covering them, and removes the buck's chest organs 106. Again, FIG. 9 is a plan view illustration of the buck 66 toward an end of the field dressing operations. In FIG. 9, the sternum 92 has been cut apart and the buck's the internal organs 93 (not expressly illustrated in FIG. 9, but see FIGS. 6-8) have been removed in accordance with aspects of the present disclosure.

In manners suitably similar to those described above, the field dressing apparatus 10 may also be used in removing pubic bones (and/or other pelvic bones) and in separating sternums (and/or other bones) of hogs, sheep, goats, cattle, bison, bear, elk, deer other than white-tailed deer, birds, and/or other game animals during field dressing operations. In some embodiments, a relatively larger-sized field dressing apparatus in accordance with aspects of the present disclosure may be suitably made and used for field dressing a relatively larger game animal, and it should be appreciated that in some embodiments, a relatively-smaller sized field dressing apparatus in accordance with aspects of the present disclosure may be suitably made and used for field dressing a relatively smaller animal.

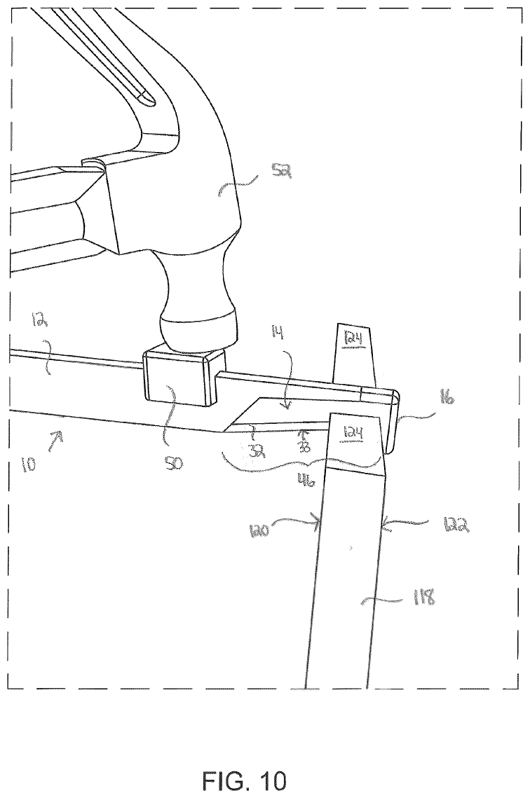

FIG. 10 is a perspective view illustration of the apparatus 10 cutting wood 118 in accordance with aspects of the present disclosure. To use the apparatus 10 for cutting the wood 118, a user abuts the blade edge 33 against a first side 124 of the wood 118, with the surface 42 (not marked in FIG. 1, but see FIGS. 2-3) of the tapered head 16 positioned against a second side 122 of the wood 118, and with the impact block 50 positioned generally between the wood 118 and the user, such that wood 118 is nestled in the notch 46 formed between the blade edge 33 and the surface 42. Next, the user drives the blade 14 through wood 118, by repeatedly striking the impact block 50 with a hammer 52 (or rock, or other suitable tool) while clutching the grip 64. The user repeatedly strikes the impact block 50 until the user has caused the apparatus 10 to cut the wood 118 as desired.

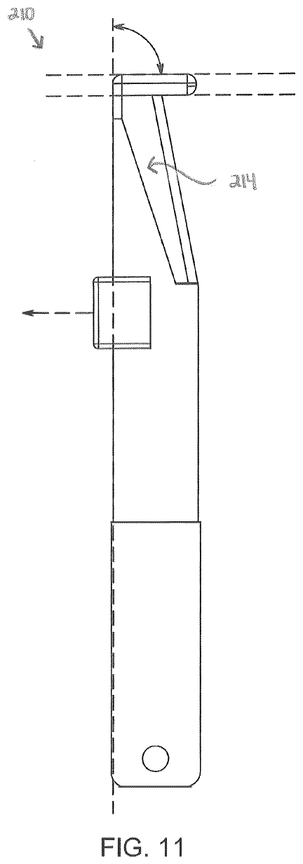

FIG. 11 is a right side plan view illustration of a second field dressing apparatus 210 in accordance with aspects of the present disclosure. The apparatus 210 includes a blade 214 having a somewhat different overall geometry than blade 14 of the apparatus 10. It should be appreciated that the apparatus 210 may be used in manners similar to the apparatus 10 (described above).

While the invention(s) has (have) been illustrated and described in detail in the drawings and foregoing description, the same is to be considered as illustrative and not restrictive in character, it being understood that only certain embodiments have been shown and described and that all changes and modifications that come within the spirit of the invention(s) are desired to be protected.

1. A field dressing apparatus, comprising:
an elongated handle including a first end and a second end;
a head member including an at least generally planar, at least substantially smooth first surface, the head member further including an at least substantially smooth second surface cresting apart from the first surface, the head member further including an at least substantially smooth and rounded tip extending between the first surface and the second surface; and
a blade fixedly attached to and extending between the second end of the handle and the first surface of the head member, the blade including a blade edge, the edge being angled relative to the handle,
wherein the blade edge and the first surface of the head member together form a notch in front of the blade edge.

2. The apparatus of claim 1, wherein the first surface of the head is at least about laterally perpendicular to the blade edge.

3. The apparatus of claim 2, wherein the second surface of the head is curved

4. The apparatus of claim 1, wherein the blade edge is at least generally straight, and the notch is not greater than about 90°.

5. The apparatus of claim 4, wherein the notch is about 77°.

6. The apparatus of claim 5, wherein the first surface of the head is at least about laterally perpendicular to the blade edge.

7. The apparatus of claim 6, wherein the second surface of the head is curved.

8. The apparatus of claim 7, wherein the first surface of the head extends away from the blade edge along a first line, and the second surface of the head crests apart from the first surface of the head along a second line at least about parallel to the first line.

9. The apparatus of claim 6, further comprising:
an impact block fixedly attached to the handle.

10. The apparatus of claim 9, wherein the handle has a first lateral span, the impact block includes an at least generally planar outwardly facing impact surface, and the impact block has a second lateral span greater than the first lateral span.

11. The apparatus of claim 10, wherein the second surface of the head is curved.

12. The apparatus of claim 11, wherein the first surface of the head extends away from the blade edge along a first line, and the second surface of the head crests apart from the first surface of the head along a second line at least about parallel to the first line.

13. The apparatus of claim 12, wherein a slip resistant grip covers at least a portion of the first end of the handle.

16. 16 (Canceled).

17. A field dressing apparatus, comprising:
a longitudinally extending handle having a first end and a second end;
an edged means, extending from the first end of the handle and angled relative to the longitudinal extension of the handle, for cutting an animal bone; and
an at least substantially smooth and rounded means, extending from the edged means, for guiding the edged means through the bone and for spacing the edged means apart from an internal organ of the animal concurrently with guiding the edged means though the bone,
wherein the at least substantially smooth and rounded means and the edged means are configured to cooperate to nestle a portion of the bone therebetween.

18. The apparatus of claim 17, wherein the handle includes a means for receiving an impact from a hammer.

19. A field dressing apparatus, comprising:
an elongated handle including a first end and a second end;
a head member including an at least generally curved, at least substantially smooth first surface, the head member further including an at least substantially smooth and generally curved second surface cresting apart from the first surface, the head member further including an at least substantially smooth and rounded tip extending between the first surface and the second surface; and
a blade fixedly attached to and extending between the second end of the handle and the first surface of the head member, the blade including a blade edge, the edge being angled relative to the handle,
wherein the blade edge and the first surface of the head member together form a notch in front of the blade edge.

20. The apparatus of claim 10, wherein the impact block has a generally rectilinear shape.

21. The apparatus of claim 10, wherein the impact block is located closer to the second end of the handle than the first end of the handle.
